(19) United States
(12) Patent Application Publication
(10) Pub. No.: US 2026/0076351 A1
(43) Pub. Date: Mar. 19, 2026

(54) LURE

(71) Applicant: Shimano Inc., Osaka (JP)

(72) Inventors: Kento INOKUCHI, Osaka (JP); Tatsurou KAWASAKI, Osaka (JP); Sadahiro TSUBOI, Osaka (JP)

(21) Appl. No.: 19/304,273

(22) Filed: Aug. 19, 2025

(30) Foreign Application Priority Data
Sep. 13, 2024 (JP) 2024-158743

(51) Int. Cl. A01K 85/12; A01K 85/00

(52) U.S. Cl. CPC A01K 85/122; A01K 85/1847

(57) ABSTRACT

A lure is provided that improves usability of a propeller. The lure according to one embodiment includes a body, a rotatable portion, and a propeller. The rotatable portion is rotatably attached to the body. The propeller is configured to be detachably attached to the rotatable portion.

### CROSS-REFERENCE TO RELATED APPLICATIONS

This application claims priority to Japanese Patent Application No. 2024-158743, filed September 13, 2024. The contents of that application are incorporated by reference herein in their entirety.

### TECHNICAL FIELD

The present disclosure relates to a lure.

### BACKGROUND ART

Japanese Utility Model Laid-Open Publication No. H05-023864 discloses a lure including a propeller on its body.

### BRIEF SUMMARY

The lure according to the prior art is configured to move on the water surface or underwater while rotating the propeller when the fishing line is pulled. The sound and splashes generated by the rotation of the propeller attract the attention of target creatures, such as predatory fish that feed on small fish.

The lure according to the prior art, however, still has room for improvement in terms of enhancing the usability of the propeller.

One objective of the present disclosure is to provide a lure with improved propeller usability.

A lure according to a first aspect of the present disclosure includes a body, a rotatable portion, and a propeller. The rotatable portion is rotatably attached to the body. The propeller is configured to be detachably attached to the rotatable portion.

According to the lure of the first aspect, the propeller is configured to be detachably attached, allowing it to be easily replaced and thereby enhancing its usability. For example, the propeller can be replaced with one of a different shape or size to suit various fishing conditions, or a damaged propeller can be replaced with a new one, thereby enhancing usability.

In the lure of a second aspect according to the first aspect, the rotatable portion includes a groove. The propeller includes a projection engageable with the groove, and is attached to or detached from the rotatable portion by sliding the projection into or out of engagement with the groove.

According to the lure of the second aspect, since attachment or detachment of the propeller is achieved by sliding the projection into or out of engagement with the groove, the propeller can be easily attached to or detached from the rotatable portion.

In the lure of a third aspect according to the second aspect, the groove includes a lock portion configured to lock the projection.

According to the lure of the third aspect, since the projection of the propeller is locked by the lock portion of the groove in the rotatable portion, the propeller is less likely to detach from the rotatable portion.

In the lure of a fourth aspect according to the second or third aspect, the groove includes an opening and a stopper. The opening is located on the front end of the groove and configured to allow the projection to pass through. The stopper is located on the rear end of the groove and configured to restrict movement of the projection.

According to the lure of the fourth aspect, the projection of the propeller is inserted through the opening of the groove and its movement is restricted by the stopper, allowing the propeller to be attached at a desired position on the rotatable portion. In a lure, for example, when the fishing line is pulled, the water resistance acts toward the rear end. In the lure of the fourth aspect, the stopper is located at the rear end of the groove. Accordingly, even when the water resistance acts toward the rear, the likelihood of detachment of the propeller from the rear end can be reduced.

In the lure of a fifth aspect according to any one of the second to fourth aspects, the body includes a recess formed on the outer surface on the rotatable-member side. The propeller is detached from the rotatable portion when the rotatable portion is rotated such that the groove is aligned with the recess and the projection is moved out of the groove into a space defined by the recess.

According to the lure of the fifth aspect, detachment of the propeller is achieved by moving the projection out of the groove in the rotatable portion into the space defined by the recess. This configuration facilitates the detachment of the propeller from the rotatable portion.

In the lure of a sixth aspect according to any one of the second to fifth aspects, the body includes a recess formed on the outer surface on the rotatable-member side. The propeller is attached to the rotatable portion when the rotatable portion is rotated such that the groove is aligned with the recess and the projection is moved out of the space defined by the recess into the groove.

According to the lure of the sixth aspect, attachment of the propeller is achieved by moving the projection out of the space defined by the recess into the groove on the rotatable portion. This configuration facilitates the attachment of the propeller to the rotatable portion.

In the lure of a seventh aspect according to the fifth or sixth aspect, the recess is formed at a location on the outer surface of the body excluding the lower portion in the up-down direction.

According to the lure of the seventh aspect, the likelihood of the propeller detaching from the rotatable portion can be further reduced. That is, when the propeller is attached to the rotatable portion, the groove of the rotatable portion tends to face downward due to the weight of the propeller. Since the propeller detaches when the rotatable portion rotates such that the groove aligns with the recess, if the recess is arranged at the lower portion in the up-down direction of the body, the groove tends to be positioned to be aligned with the recess, making it easier for the propeller to detach from the rotatable portion. In the lure of the seventh aspect, the recess is formed in a portion of the outer surface of the body excluding the lower portion in the up-down direction. Thus, the groove to which the propeller is attached is less likely to be positioned corresponding to the recess. Consequently, the propeller is less likely to detach from the rotatable portion.

In the lure of an eighth aspect according to the seventh aspect, the body includes multiple recesses. The recesses are symmetrically positioned with respect to an imaginary plane passing through the center of the body in the left-right direction.

According to the lure of the eighth aspect, since multiple recesses are well-balanced in the left-right direction of the body, the design can be improved. In the lure of the eighth aspect, the balanced arrangement of the multiple recesses in the left-right direction also allows the lure to move in a stable posture along the direction in which the fishing line is pulled.

According to the lure of the present disclosure, the usability of the propeller can be improved.

### BRIEF DESCRIPTION OF THE DRAWINGS

FIG. 1 is a side view of a lure according to an embodiment.

FIG. 2 is a bottom view of a lure according to an embodiment.

FIG. 3 is a cross-sectional view taken along line III-III in FIG. 2.

FIG. 4 is a perspective view of a rotatable portion.

FIG. 5 is a cross-sectional view taken along line V-V in FIG. 4.

FIG. 6 is a cross-sectional view taken along line VI-VI in FIG. 4.

FIG. 7 is a perspective view of a propeller.

FIG. 8 is a cross-sectional view taken along line VIII-VIII in FIG. 1.

FIG. 9 is a diagram illustrating attachment and detachment of a propeller.

### DETAILED DESCRIPTION

With reference to FIGS. 1 to 3, a lure 2 according to an embodiment is described. The lure 2 is, for example, a lure used to capture large (predatory) fish that prey on small fish. Such large fish include largemouth bass, yellowtail, juvenile yellowtail, and sea bass. The lure 2 has a shape that imitates a small fish.

In this disclosure, the terms indicating directions, such as "front," "rear," "forward (front side)," "rearward (rear side)," "left," "right," "leftward," "rightward," "up," "down," "upward," "downward," and any other similar directional terms, are defined as follows.

"Front" and "forward (front side)" refer to the direction in which the lure 2 moves when pulled by a fishing line attached to the lure 2. "Rear" and "rearward (rear side)" refer to the direction opposite to the direction of advancement of the lure 2. The "front-rear direction" corresponds to the longitudinal direction of the lure 2.

"Up" and "upward" refer to the direction toward the water surface when the lure 2 is advancing underwater. "Down" and "downward" refer to the direction toward the bottom of the water when the lure 2 is advancing underwater. "Left," "leftward," "right," and "rightward" are defined based on "up" and "down."

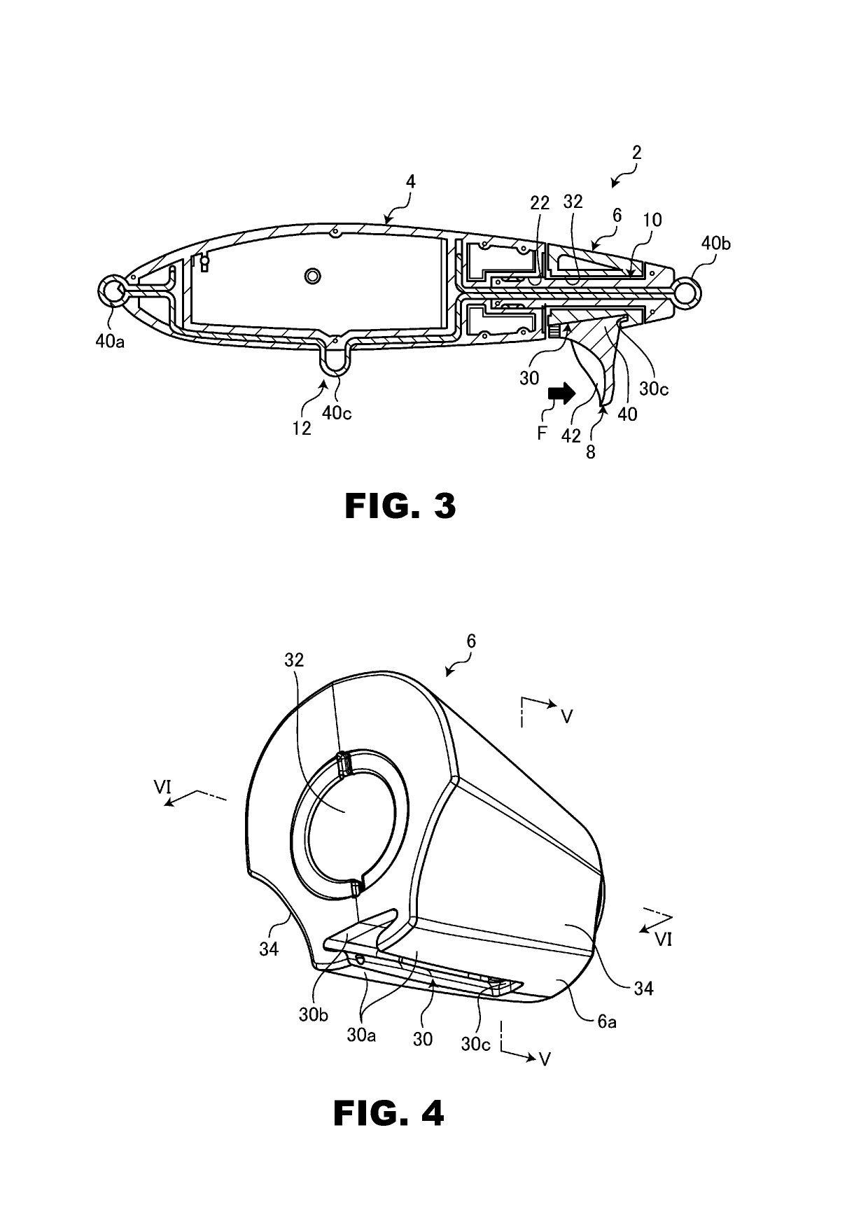

As illustrated in FIGS. 1 to 3, the lure 2 includes a body 4, a rotatable portion 6, and a propeller 8. The lure 2 further includes a shaft 10 (see FIG. 3) and a wire 12. Some or all of these components of the body 4 may be made from resin or metal.

The body 4 extends in the front-rear direction. The body 4 has a hollow shape. The body 4 may be filled with filler material. The body 4 includes recesses 20. Details of the recesses 20 will be described later with reference to FIG. 8. The outer surface 4a of the body 4 may be decorated by painting, printing, or attaching fabric, for example.

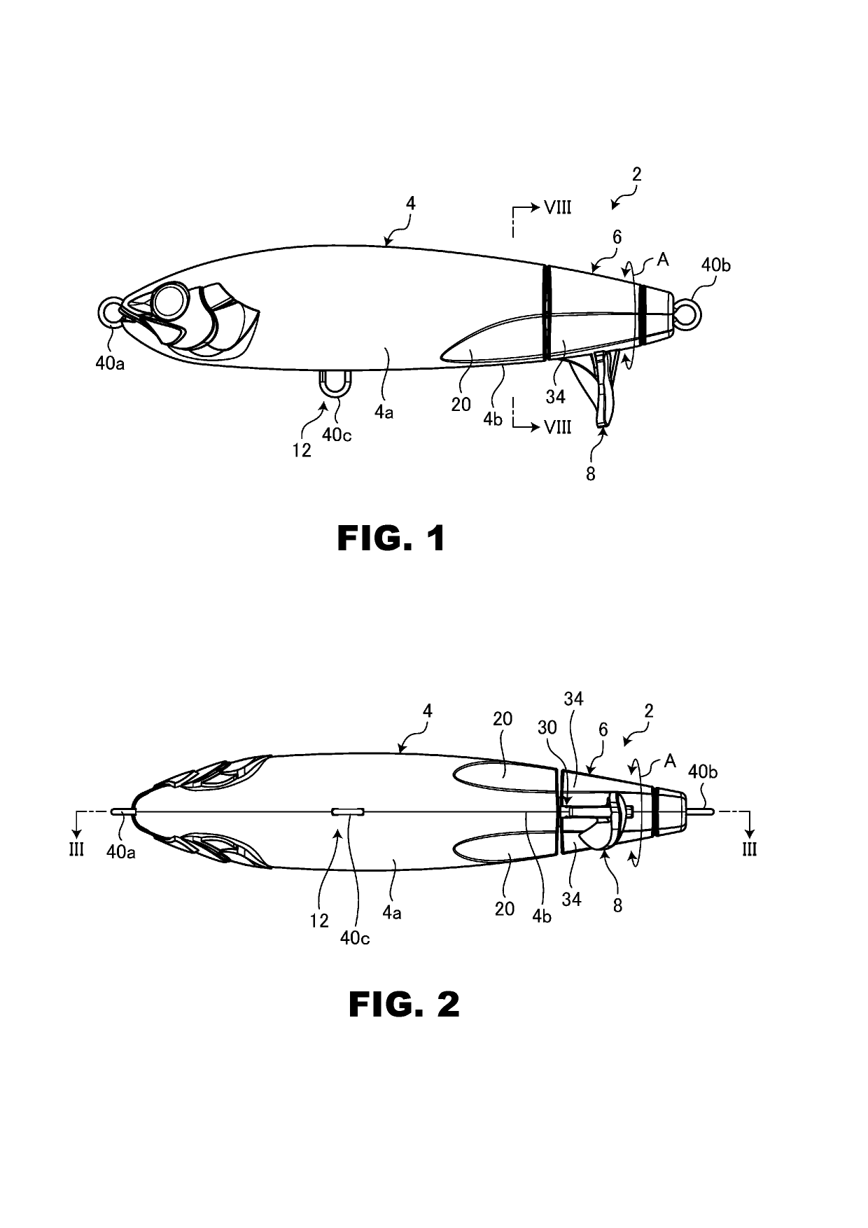

As illustrated by arrow A in FIGS. 1 and 2, the rotatable portion 6 is rotatably attached to the body 4. The rotatable portion 6 will be described with reference to FIGS. 4 to 6. The rotatable portion 6 is in a cylindrical shape. The rotatable portion 6 includes a groove 30. The rotatable portion 6 further includes a shaft hole 32, and recesses 34 on the rotatable-member side.

The shaft hole 32 is a hole that penetrates the rotatable portion 6 along the front-rear direction. The shaft hole 32 has a diameter larger than that of the shaft 10 (see FIG. 3). The shaft 10 is inserted through the shaft hole 32. As illustrated in FIG. 3, the shaft 10 is inserted into an insertion hole 22 and fixed there. The insertion hole 22 is located at the rear end of the body 4. Thus, the rotatable portion 6 is set rotatable with respect to the body 4 with the shaft 10 serving as a central axis.

The groove 30 is formed on the outer surface 6a of the rotatable portion 6. The groove 30 is a groove-shaped recess extending in the front-rear direction. The groove 30 is a portion where the propeller 8 is attached. When the groove 30 engages with a projection 40 of the propeller 8 (see FIG. 3), which will be described later, the propeller 8 is attached to the rotatable portion 6.

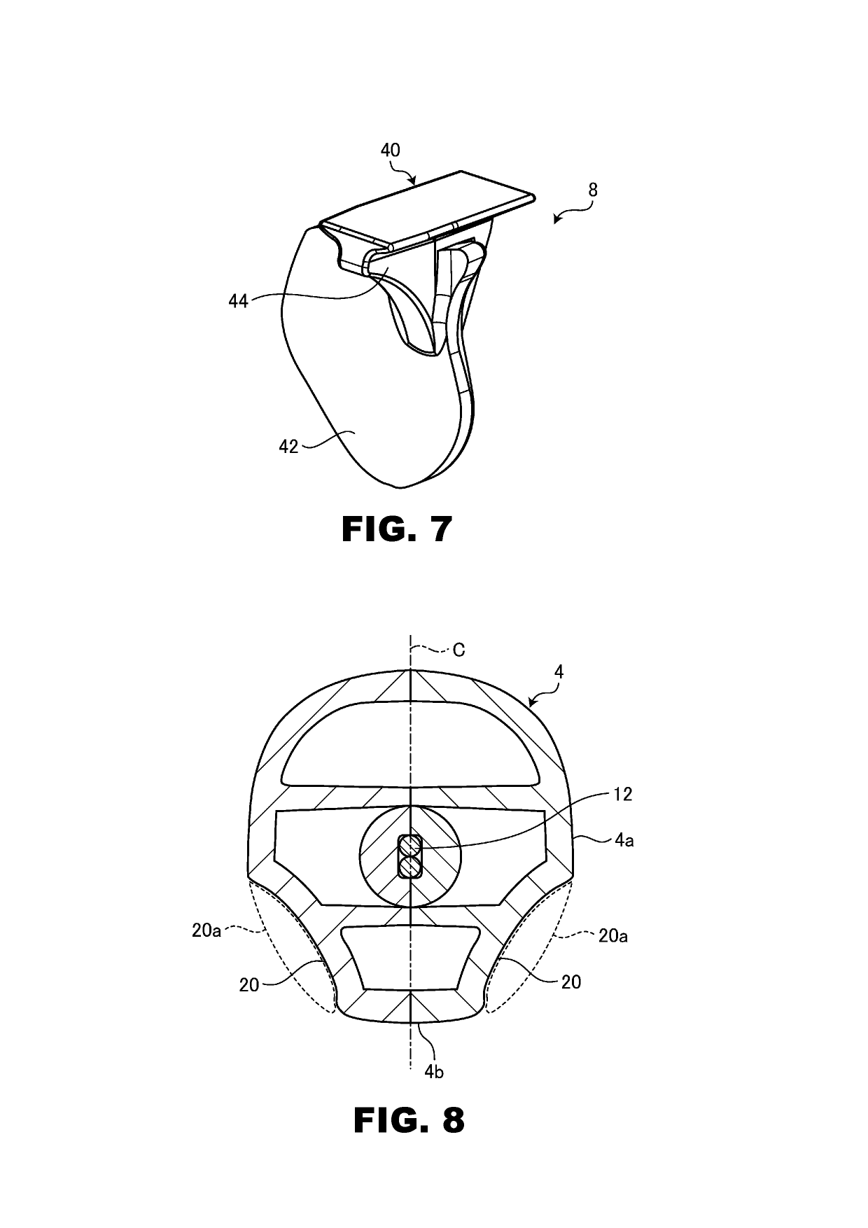

The propeller 8 is now described with reference to FIG. 7. As illustrated in FIG. 7, the propeller 8 includes the projection 40. The propeller 8 also includes a blade portion 42 and a connecting portion 44.

The blade portion 42 may have a curved shape, for example. The blade portion 42 is shaped such that it causes the rotatable portion 6 to which the propeller 8 is attached to rotate when the fishing line is pulled and water resistance (force F; see FIG. 3) is applied. With this configuration, when the fishing line is pulled, the propeller 8 rotates and generates sound and splashes, thereby attracting the interest of target organisms.

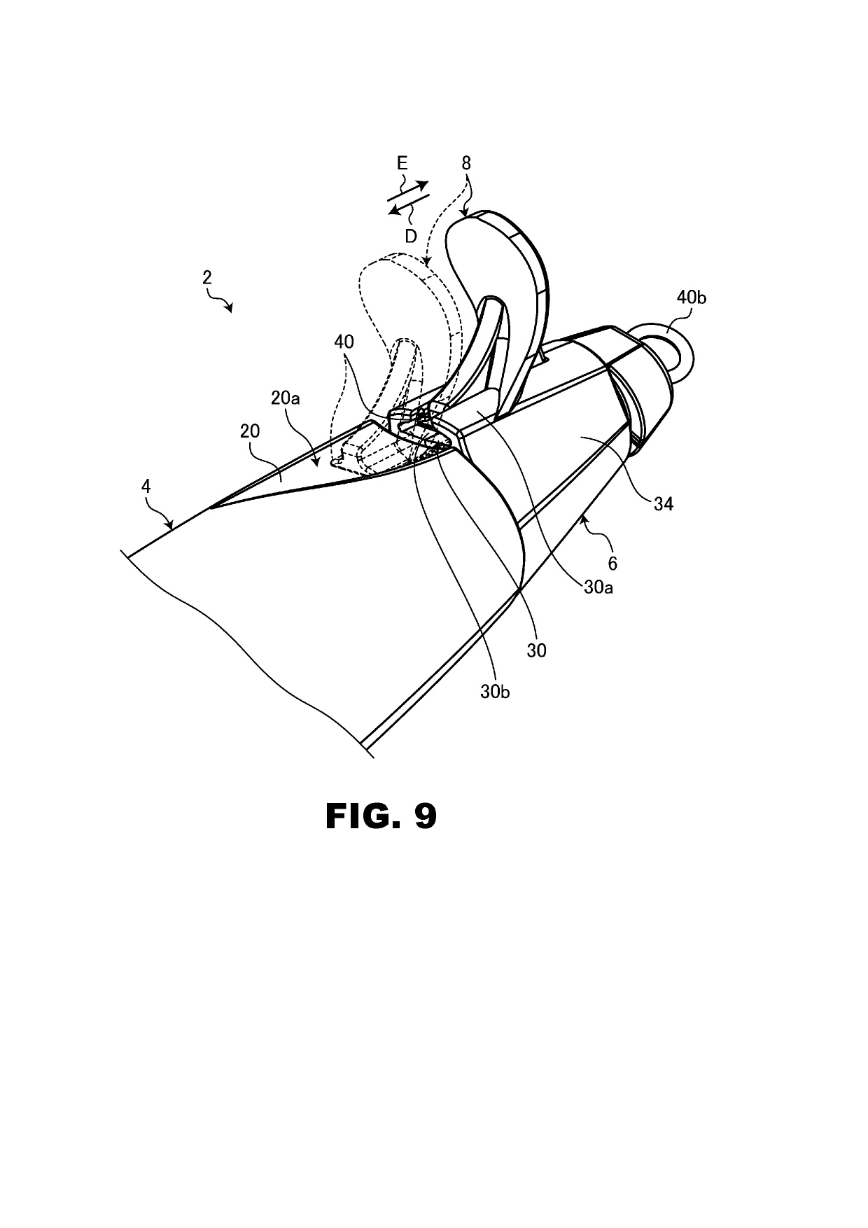

The projection 40 protrudes from the blade portion 42. The projection 40 is engageable with the groove 30 of the rotatable portion 6. The projection 40 may have a flat plate shape, for example. The projection 40 extends along the front-rear direction. The connecting portion 44 connects the blade portion 42 and the projection 40. The propeller 8 is attachable to and detachable from the rotatable portion 6. Details of attachment and detachment of the propeller 8 will be described later with reference to FIG. 9.

The groove 30 is now described in detail with reference to FIGS. 4 to 6. The groove 30 includes lock portions 30a. The groove 30 further includes an opening 30b and a stopper 30c.

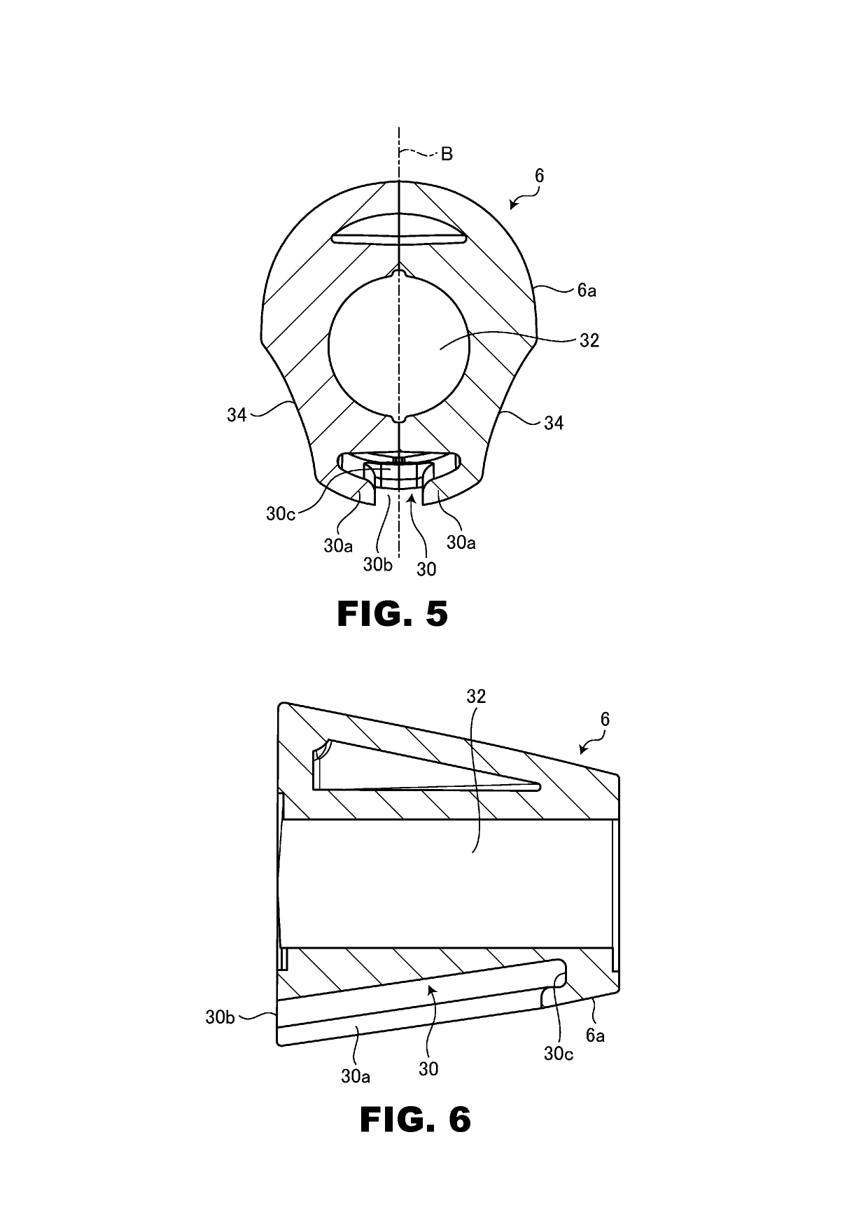

The lock portions 30a partially cover the grooved area of the groove 30. Specifically, as illustrated in FIG. 5, the lock portions 30a extend continuously from both ends of the groove 30 in the left-right direction. The lock portions 30a cover the areas near both ends of the grooved portion in the left-right direction while ensuring a space into which the projection 40 of the propeller 8 can be inserted. With this configuration, the lock portions 30a lock the projection 40 of the propeller 8 when attached to the groove 30 (see FIG. 9, described later). Accordingly, the propeller 8 is less likely to detach from the rotatable portion 6.

The opening 30b is located on the front-end side of the groove 30. The opening 30b is open toward the front. The opening 30b is shaped to allow the projection 40 of the propeller 8 to pass through.

The stopper 30c is positioned on the rear-end side of the groove 30. The stopper 30c may be, for example, a wall protruding from the grooved portion of the groove 30. The stopper 30c restricts the movement of the projection 40 by contacting the projection 40 of the propeller 8. That is, the stopper 30c restricts the rearward movement of the propeller 8 by contacting the projection 40. As a result, the propeller 8 is attached at a desired position on the rotatable portion 6. Since the lure 2 includes the stopper 30c and other structural features, even when the fishing line is pulled and the water resistance (force F, see FIG. 3) acts toward the rear-end side, the likelihood of detachment of the propeller 8 from the rear-end side can be reduced.

The recesses 34 on the rotatable-member side are located on the outer surface 6a of the rotatable portion 6. The recesses 34 are recessed inward from the outer surface 6a of the rotatable portion 6. The recesses 34 extend along the front-rear direction of the rotatable portion 6. There are multiple recesses 34 on the rotatable-member side. For example, two recesses 34 may be formed. As illustrated in FIG. 5, multiple recesses 34 on the rotatable-member side 34 are arranged symmetrically with respect to an imaginary plane B passing through the center in the left-right direction of the rotatable portion 6. When viewed from the front of the rotatable portion 6, the recesses 34 are symmetrical along the left-right axis.

Here, the recesses 20 of the body 4 are described in detail with reference to FIGS. 1, 2, and 8. The body 4 includes the recesses 20. As illustrated in FIGS. 1 and 2, the recesses 20 are located on the outer surface 4a of the body 4 on the side closer to the rotatable portion 6. The recesses 20 are positioned on the rear-end side of the outer surface 4a of the body 4. The recesses 20 are recessed inward from the outer surface 4a of the body 4. The recesses 20 extend in the longitudinal direction of the body 4. There are multiple recesses 20 in the body 4. For example, two recesses 20 may be formed. The recesses 20 are located on a portion of the outer surface 4a of the body 4 excluding the lower portion 4b in the up-down direction. Specifically, as illustrated in FIG. 8, the recesses 20 are symmetrical with respect to an imaginary plane C passing through the center in the left-right direction of the body 4. The recesses 20 are symmetrical in the left-right direction when viewed from the front of the body 4.

The recesses 20 are located within a predetermined angular range of the 360-degree periphery of the outer surface 4a of the body 4 when viewed from the front of the body 4. The predetermined range may be set to any value. For example, the predetermined range may be set to 30 degrees.

Each recess 20, which is a concave portion, defines a space 20a in the body 4. In FIG. 8, for illustrative purposes, the space 20a is illustrated with dashed lines. The lure 2 enables attachment and detachment of the propeller 8 by utilizing this space 20a. Details of the attachment and detachment of the propeller 8 will be described later with reference to FIG. 9.

The recesses 34 on the rotatable portion 6 described above are shaped, as illustrated in FIGS. 1 and 2, to be continuous in the front-rear direction with the recesses 20 when the rotatable portion 6 rotates into alignment with the recesses 20 of the body 4. With this configuration, the lure 2 has a design in which the recessed portions extend in the front-rear direction from the recesses 20 to the recesses 34 on the rotatable-member side, thereby enhancing its aesthetic appearance.

As illustrated in FIGS. 1 to 3, the wire 12 includes a first eye 40a, and second eyes 40b and 40c. The wire 12 is made of wire material. The wire 12 extends in the front-rear direction. As illustrated in FIG. 3, the wire 12 is attached to the body 4 and the shaft portion 10. The eyes 40a to 40c are arranged so that at least a portion of each is exposed from the body 4. The first eye 40a is arranged on the front-end side of the lure 2. The first eye 40a is configured to connect to a fishing line. The second eye 40b is arranged on the rear-end side of the lure 2 and is configured to connect to a hook. The second eye 40c is arranged on the lower-end side of the lure 2 and is also configured to connect to a hook. The second eye 40c is positioned between the first eye 40a and the second eye 40b.

The attachment and detachment of the propeller 8 are described in detail with reference to FIG. 9. FIG. 9 is an enlarged perspective view of the rotatable portion 6 and the propeller 8 of the lure 2. In FIG. 9, the propeller 8 is illustrated in a solid line when attached (or before detachment), and in a dashed line when detached (or before attachment).

The propeller 8 is detachably attached to the rotatable portion 6. Specifically, the propeller 8 is attached to or detached from the rotatable portion 6 when the projection 40 slides into engagement with the groove 30 of the rotatable portion 6 or slides out of the engagement (see arrows D and E). The attachment and detachment of the propeller 8 are performed by the user.

More specifically, when the propeller 8 is detached from the rotatable portion 6, the rotatable portion 6 is first rotated so that the groove 30 aligns with a recess 20 in the body 4. Specifically, the rotatable portion 6 is rotated until the opening 30b of the groove 30 is aligned with a recess 20 of the body 4. As a result, in the lure 2, the space 20a defined by the opening 30b of the groove 30 and the recess 20 in the body 4 form a continuous path.

After the rotatable portion 6 rotates in the state where the groove 30 aligns with the recess 20, the projection 40 is then moved out of the groove 30 into the space 20a of the recess 20 (see arrow D). Specifically, the projection 40 slides through the groove 30 of the rotatable portion 6 and is then moved into the space 20a defined by the recess 20. As a result, the propeller 8 is easily detached from the rotatable portion 6.

In the lure 2, if the rotatable portion 6 is rotated into a state where the groove 30 is not aligned with a recess 20, the projection 40 cannot move out of the groove 30 into the space 20a of the recess 20. Accordingly, the propeller 8 is not detached from the rotatable portion 6 in the state.

When the propeller 8 is to be attached to the rotatable portion 6, the rotatable portion 6 is first rotated so that the groove 30 aligns with the recess 20 of the body 4. Specifically, the rotatable portion 6 is rotated until the opening 30b of the groove 30 is aligned with the recess 20 in the body 4. As a result, the space 20a defined by the opening 30b of the groove 30 and the recess 20 in the body 4 communicate with each other.

After the rotatable portion 6 rotates in the state where the groove 30 aligns with the recess 20, the projection 40 is moved out of the space 20a of the recess 20 into the groove 30 (see arrow E). Specifically, the projection 40 is moved out of the space 20a of the recess 20 into the groove 30 of the rotatable portion 6 and then slides within the groove 30. As a result, the propeller 8 is easily attached to the rotatable portion 6.

In the above embodiment, an example is illustrated in which the lure 2 has one propeller 8. However, multiple propellers 8 may be included. Also, while the above embodiment shows an example in which the body 4 has two recesses 20, the number of recesses 20 may be one, or three or more. Furthermore, two rotatable portion-side recesses 34 of the rotatable portion 6 are illustrated in the above embodiment. However, either a single recess 34, or three or more recesses 34 may be included on the rotatable-member side.

The expression “at least one” as used in this specification means “one or more” of the desired options. For example, when two options are presented, the expression “at least one” refers to either “only one of the options” or “both of the two options.” In another example, when three or more options are presented, the expression “at least one” refers to either “only one of the options” or “any combination of two or more options.”

### REFERENCE SIGNS LIST

2: Lure, 4…Body, 6: Rotatable portion, 8: Propeller, 20: Recess, 30: Groove, 30a: Lock portion, 30b: Opening, 30c: Stopper, 40: Projection

What is claimed is:

1. A lure comprising:
a body;
a rotatable portion rotatably attached to the body; and
a propeller configured to be detachably attached to the rotatable portion.

2. The lure according to claim 1, wherein
the rotatable portion includes a groove, and
the propeller includes a projection engageable with the groove, the propeller being attached to or detached from the rotatable portion by sliding the projection into or out of engagement with the groove.

3. The lure according to claim 2, wherein
the groove includes a lock portion configured to lock the projection.

4. The lure according to claim 2, wherein
the groove includes an opening and a stopper,
the opening being located on the front end of the groove and being configured to allow the projection to pass through,
the stopper being located on the rear end of the groove and being configured to restrict movement of the projection.

5. The lure according to claim 2, wherein
the body includes a recess formed on the outer surface on a rotatable-member side, and
the propeller detaches from the rotatable portion when the rotatable portion is rotated such that the groove is aligned with the recess and the projection is moved out of the groove into a space defined by the recess.

6. The lure according to claim 2, wherein
the body includes a recess formed on the outer surface on a rotatable-member side, and
the propeller is attached to the rotatable portion when the rotatable portion is rotated such that the groove is aligned with the recess and the projection is moved out of the space defined by the recess into the groove.

7. The lure according to claim 5, wherein
the recess is formed at a location on the outer surface of the body excluding the lower portion in the up-down direction.

8. The lure according to claim 7, wherein
the body includes multiple recesses, and
the recesses are symmetrically positioned with respect to an imaginary plane passing through the center of the body in the left-right direction.
